(19) United States
(12) Patent Application Publication
(10) Pub. No.: US 2003/0065587 A1
(43) Pub. Date: Apr. 3, 2003

(54) Presentation of personalized merchandise in an electronic commerce transaction

(76) Inventors: Robert L. Parker, Phoenix, AZ (US); John Hart, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/970,535

(22) Filed: Oct. 3, 2001

(51) Int. Cl. G06F 17/60; G09G 5/00

(52) U.S. Cl. 705/27; 345/629

(57) ABSTRACT

A method includes providing a first image of an article of merchandise available to a consumer in an electronic commerce transaction, projecting a second image onto the first image of the article of merchandise to produce a third image representing the article of merchandise as personalized by the second image, and providing the third image for display to the consumer to facilitate an electronic commerce transaction.

### FIELD

The invention relates to the presentation of images of merchandise to a consumer during an electronic commerce transaction, and, more particularly, to producing an image of a personalized good by combining an image of the good and another image provided or selected by the consumer.

### BACKGROUND

The rise of public computer networks, and the World Wide Web (WWW) portion of the Internet in particular, have provided opportunity for the marketing and sales of products online. Often, the products offered online are provided “as is”, with no opportunity for the consumer to customize, personalize, or otherwise alter what they eventually purchase. An increasingly popular product category is “personalized” or customized merchandise, in which the consumer is provided the opportunity to specify artwork, patterns, decals, letters, photos, and so on, to apply to the products which they purchase. Personalization provides that “personal touch” which may sway a consumer toward making a purchase.

One problem with current personalization approaches is that the consumer may not have a realistic representation of the final product available for review and approval before making the purchase decision. Often the consumer would like to see how the personalized product will actually look before spending his or her money. Techniques for providing a realistic representation of a personalized product on, for example, a web page, may help improve the online shopping experience, and thus lead to increased sales.

### FIGURES

The invention may be better understood with reference to the following figures in light of the accompanying description. The present invention, however, is limited only by the scope of the claims at the concluding portion of the specification.

FIG. 1 shows an image of a cup representative of an article of merchandise made available to a consumer.

FIG. 2 shows an example of an image provided by the consumer.

FIG. 3 shows an embodiment of a composite image of the personalized merchandise in accordance with the present invention.

FIG. 4 shows a process for ordering personalized merchandise according to an embodiment of the present invention.

FIG. 5 shows an embodiment of a system supporting presentation of personalized merchandise in accordance with the present invention.

### DETAILED DESCRIPTION

In the following description, references to “one embodiment” or “an embodiment” do not necessarily refer to the same embodiment, although they may. Various operations of the description below and the claims are described in terms of software, e.g. instructions executed by a processor, either a general purpose processor, or a more task-specific processor such as an embedded processor or digital signal processor. However, the various operations may of course be embodied by software, hardware, firmware, or a combination thereof.

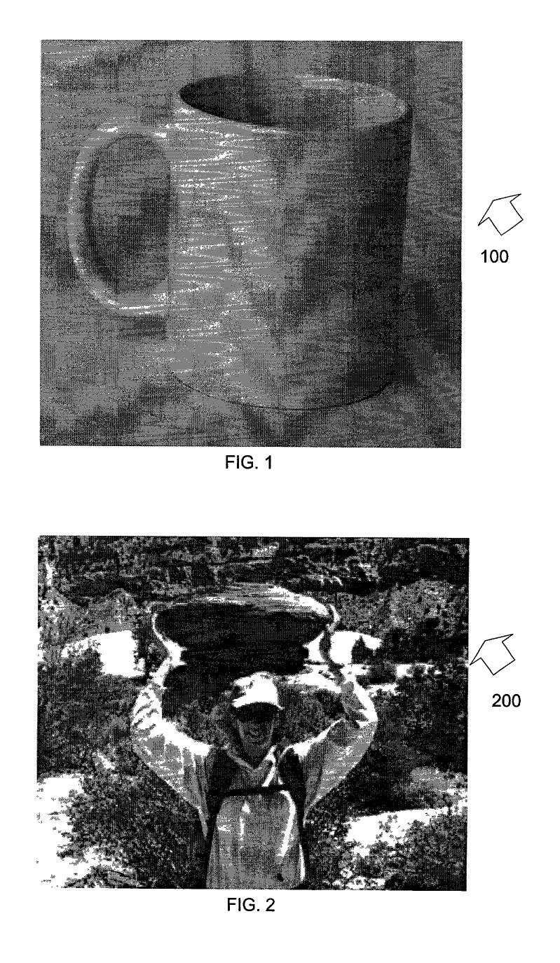

FIG. 1 shows an embodiment 100 of an image of a cup in accordance with the present invention. The cup is used herein as an example of an article of merchandise that may be personalized for sale to a consumer. Of course, in accordance with the present invention, many other items of merchandise may be used and the invention is not limited in scope in this respect. In one embodiment, the image of the cup as an available article of merchandise (either for free or for purchase) may be presented to a consumer on a web page of the WWW. The web page may be presented to the display of a consumer's client device using a browser application as is well-known in the art. The consumer may be browsing a web site containing the web page as part of an online shopping experience. The image of the cup is generic; although the cup may be offered for sale in different sizes and colors, there are no features of the cup which identify it as unique to a particular individual. A consumer may wish to personalize the cup with their name, a favorite saying, a personal photograph, artwork, decals, and so on. For example, a consumer may wish to apply the image 200 of FIG. 2 to the cup, to memorialize a camping trip. Prior approaches have provided the consumer with a mechanism for specifying such personalized features to apply to the cup, but have not provided a realistic manner of showing the consumer how the final, personalized product will look prior to making a purchase decision.

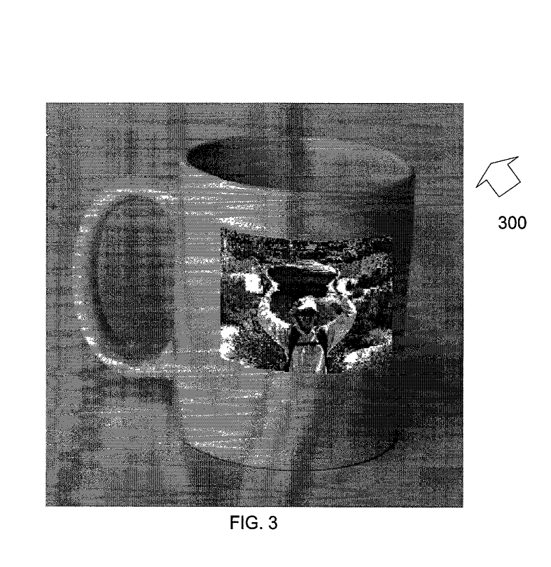

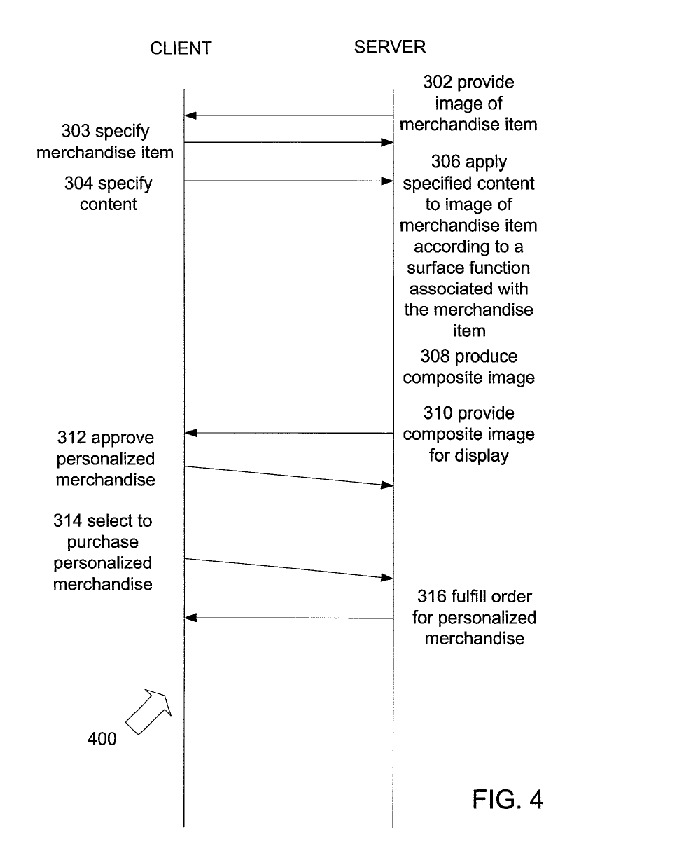

FIG. 3 shows a composite image in accordance with an embodiment of the present invention. The personal photo 200 of FIG. 2 has been projected onto the image 100 of the cup of FIG. 1. The composite image 300 may then be shown to the consumer via a web page as part of an electronic commerce transaction. One process of providing such a projection of the personalized merchandise is described more fully with respect to FIG. 4. The result is a composite image that realistically represents the appearance of the personalized merchandise (e.g., the cup as personalized by the consumer). Note that image 200 is not just placed (or pasted) over the image 100; instead image 200 is mathematically projected onto the item represented in image 100. This gives the consumer the view of the merchandise as it will look after the image 200 has been physically applied to it.

FIG. 4 shows a process for ordering personalized merchandise according to an embodiment of the present invention. At 302, the client device of an online consumer (e.g., a personal computer (PC), a handheld computer, a personal digital assistant (PDA), a cell phone, or other processing device executing a browser application program and coupled to a computer network such as the Internet) may be provided with an image of an article of merchandise by a server computer (e.g., a server of a merchant web site). At 303, the consumer (via interaction between the client device and the server of a merchant web site) specifies or otherwise selects the image of the item of merchandise of interest to the consumer. At 304, the consumer specifies personalized content to be applied to the merchandise item. This content may take the form of text, image, other content (such as, for example, a bit sequence representing a personal signature or other symbol), or any other visual form. When the content is an image, it may be, for example, a personal photo, an image of artwork, a decal, a logo, an icon, a pattern, a design, and so on. In one embodiment, the image may be either two-dimensional (2D) or three-dimensional (3D).

The consumer may provide the content, for example by uploading, e-mailing, or otherwise electronically communicating the content to the site that is offering the merchandise. Alternately, server computer operating the web site that offers the merchandise may provide the consumer with the capability to create or select the previously created content. In this instance, the content may be provided on a web page for the consumer to select particular images from, or the content may be interactively created by the consumer using a content creation application program (e.g., a drawing program). The server computer may receive communications from the client device as commands to create the content.

At 306, the personalizing content is mathematically projected onto the image of the article of merchandise according to a surface function of the article of merchandise using techniques known in the 2D and 3D computer graphics arts to produce a composite image. The projection may be done at a location on the image of the item of merchandise specified by the consumer, or at a predetermined location.

One method for accomplishing that projection is described herein, using the coffee cup example. First, the surface of the coffee cup may be described mathematically. Ignoring the cup handle, the cup can be modeled as a cylinder with, for example, a 2-inch radius and a 4-inch height. Using the standard (r, theta, z) cylindrical coordinate system (see, for example, “Calculus with Analytical Geometry”, authored by Howard Anton, and published by Wiley, New York, 1980, p. 875), a cylinder is described by (r=2, 0 degrees<theta<=360 degrees, 0<=z<=4). Next, the position of the display screen that contains the image may be described. In the mathematics language, the screen is equivalent to a plane. In this description, suppose the screen is placed directly in line of sight between an imaginary viewer and the cup, with the screen 4 inches from the cup and square to the viewer. Suppose further that the size of the image on the screen is two inches high by two inches wide. The simplest description for the screen, using the standard (x, y, z) Euclidean coordinates, is (x=2, 1<=y<=3, 1<=z<=3). Next, a set of rays may be described that will pass through the screen until they intersect the cup. There must be one ray for each pixel. Continuing the example above, the ray passing through the center of the image is described by (z=2, y=0, −∞<×<∞). Repeating this for each pixel of the image, each ray casts a pixel from the image to the cup, completing the projection and updating the representation of the cup to contain the image as intended.

It is important to note that this is just one method for accomplishing the projection; one skilled in the art of computer graphics—for instance, a developer of 3D game software—would be expected to apply any of a number of techniques for improving the speed of computation and the quality of this projection.

When the article of merchandise is in other shapes or forms, other appropriate well-known mathematical functions may be used to perform the projections.

At 308, a composite image may be produced, with the surface projection of the personalizing content superimposed on the image of the article of merchandise. At 310, the composite image may be provided to the client device for display to the consumer, providing the consumer with a realistic representation of how the personalized item will look once it is manufactured and personalized. In one embodiment, a web page including the composite image may be sent to the consumer's client device. At 312, the consumer may approve or reject the personalized article of merchandise. Once approved, at 314, the consumer may select to purchase the personalized article of merchandise. At 316, the purchase request for the merchandise as personalized is fulfilled by concluding the electronic commerce transaction and shipping the personalized merchandise to the consumer.

In one embodiment, the personalized article of merchandise may be the composite image rather than the physical article. In this case, the consumer may purchase or otherwise receive the composite image (in either electronic or tangible form). In another embodiment, the above process may be performed in person and in real-time. For example, a consumer may be in a shopping mall or store, a vendor may scan the consumer's photograph, and the vendor may show the consumer immediately what the article of merchandise will look like prior to actual production of the personalized merchandise. In this case, a vendor may have a personal computer system and scanner with associated software to implement the present invention.

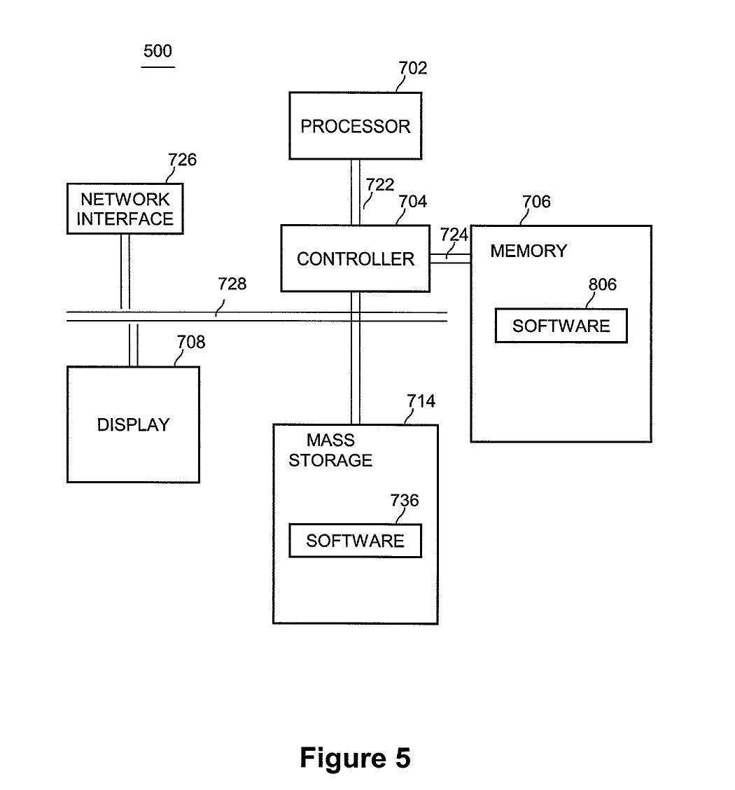

FIG. 5 shows a system 700 for supporting presentation of personalized merchandise in an electronic commerce transaction in accordance with an embodiment of the present invention. System 700 comprises a processor 702 coupled to a controller 704 by way of a processor bus 722, commonly referred to as a front side bus. Bus controller 704 is coupled to memory 706 via memory bus 724. Bus controller 704 is also coupled to various peripheral devices such as mass storage 714, network interface 726, and display 708 via I/O bus 728. Network interface 726 provides apparatus 700 with access to networks such as the Internet or corporate intranets. Memory 706 stores a software embodiment 734 to perform operations to implement the presentation of a personalized good to a consumer in an electronic commerce transaction as herein described and in accordance with the present invention. Software 734 may be stored in memory 706 in a form suitable for access and execution by processor 702. An archived loadable form 736 of software 734 may be stored by mass storage 714 for loading into memory 706 for execution by processor 702. Mass storage 714 may comprise any form of non-volatile memory including hard drives, CD ROM drives, ZIP drives, diskettes, and so on.

Memory 706 is typically a form of random access memory (RAM) such as a DRAM, flash memory, SDRAM, and so on. Memory 706 supplies the instructions of software 734 stored therein to processor 702 for execution. Execution of software embodiment 734 by processor 702 may result in a process to perform operations to implement presentation of personalized goods, as herein described and in accordance with the present invention.

Those skilled in the art will appreciate that other embodiments could comprise different combinations of software, hardware, and firmware than those illustrated to carry out the operations of the present invention as well.

While certain features of the invention have been illustrated as described herein, many modifications, substitutions, changes and equivalents will now occur to those skilled in the art. It is, therefore, to be understood that the appended claims are intended to cover all such embodiments and changes as fall within the true spirit of the invention.

### Appendix A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486; Sanjeet Dutta, Reg. No. P46,145; Matthew C. Fagan, Reg. No. 37,542; Tarek N. Fahmi, Reg. No. 41,402; Mark W. Farrell, Reg. No. 45,988; George Fountain, Reg. No. 37,374; James Y. Go, Reg. No. 40,621; James A. Henry, Reg. No. 41,064; Willmore F. Holbrow III, Reg. No. P41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George B. Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. 47,758; Joseph Lutz, Reg. No. 43,765; Michael J. Mallie, Reg. No. 36,591; Andre L. Marais, under 37 C.F.R. §10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Edwin H. Taylor, Reg. No. 25,129; Lance A. Termes, Reg. No. 43,184; John F. Travis, Reg. No. 43,203; Joseph A. Twarowski, Reg. No. 42,191; Kerry D. Tweet, Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafman, Reg. No. 26,250; my patent attorneys, and Firasat Ali, Reg. No. 45,715; Richard Nakashima, Reg. No. 42,023, my patent agents of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Ben Burge, Reg. No. 42,372; Robert A. Burtzlaff, Reg. No. 35,466; Richard C. Calderwood, Reg. No. 35,468; Jeffrey S. Draeger, Reg. No. 41,000; Cynthia Thomas Faatz, Reg No. 39,973; Jeffrey B. Huter, Reg. No. 41,086; John Kacvinsky, Reg. No. 40,040; Seth Z. Kalson, Reg. No. 40,670; David J. Kaplan, Reg. No. 41,105; Peter Lam, Reg. No. 44,855; Anthony M. Martinez, Reg. No. 44,223; Paul Nagy, Reg. No. 37,896; Leo V. Novakoski, Reg. No. 37,198; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Robert G. Winkle, Reg. No. 37,474; Sharon Wong, Reg. No. 37,760; Steven D. Yates, Reg. No. 42,242; Calvin E. Wells; Reg. No. 43,256 and Charles K. Young, Reg. No. 39,435; my patent attorneys, and my patent agents, of INTEL CORPORATION; and James R. Thein, Reg. No. 31,710, my patent attorney; with full power of substitution and revocation, to prosecute this application and to transact all business in the Patent and Trademark Office connected herewith.

What is claimed is:

1. A method comprising:
providing a first image of an article of merchandise available to a consumer in an electronic commerce transaction;
projecting a second image onto the first image of the article of merchandise to produce a third image representing the article of merchandise as personalized by the second image; and
providing the third image for display to the consumer to facilitate an electronic commerce transaction.

2. The method of claim 1 further comprising accepting an order from the consumer to purchase the article of merchandise as personalized by the second image.

3. The method of claim 2 further comprising fulfilling an order for purchase of the article of merchandise by the consumer, the article of merchandise corresponding to the image of the article of merchandise as personalized with the second image.

4. The method of claim 1, further comprising receiving, by a server computer, the second image from a client device of the consumer, the server computer producing the third image.

5. The method of claim 1, further comprising creating the second image by a server computer as a result of communications received from a client device of the consumer, the server computer producing the third image.

6. An article comprising:
a machine accessible storage medium storing instructions, which when executed cause a system to provide a first image of an article of merchandise available to a consumer in an electronic commerce transaction, project a second image onto the first image of the article of merchandise to produce a third image representing the article of merchandise as personalized by the second image, and provide the third image for display to the consumer to facilitate an electronic commerce transaction.

7. The article of claim 6 further comprising instructions for accepting an order from the consumer to purchase the article of merchandise as personalized by the second image.

8. The article of claim 7 further comprising instructions for fulfilling an order for purchase of the article of merchandise by the consumer, the article of merchandise corresponding to the image of the article of merchandise as personalized with the second image.

9. The article of claim 6, further comprising instructions for receiving, by a server computer, the second image from a client device of the consumer, the server computer producing the third image.

10. The article of claim 6, further comprising instructions for creating the second image by a server computer as a result of communications received from a client device of the consumer, the server computer producing the third image.

11. A method of presenting images of personalized merchandise in an electronic commerce transaction comprising:
providing an image of an article of merchandise offered for sale by a merchant in an electronic commerce transaction;
providing an online consumer with at least one of a selection of personalizing content, a mechanism for creating personalizing content, and a manner of uploading personalizing content;
projecting the personalizing content onto the image of the article of merchandise to produce a composite image representing the article of merchandise as personalized by the personalizing content; and
providing the composite image for display by a client device of the consumer to facilitate the electronic commerce transaction with the merchant.

12. The method of claim 11 further comprising accepting an order by the merchant from the consumer to purchase the article of merchandise as personalized by the composite image.

13. The method of claim 12 further comprising fulfilling, by the merchant, an order for purchase of the article of merchandise by the consumer, the article of merchandise corresponding to the image of the article of merchandise as personalized with the composite image.

14. An article comprising:
a machine accessible storage medium storing instructions, which when executed cause a system to present personalized merchandise in an electronic commerce transaction by providing an image of an article of merchandise offered for sale by a merchant in an electronic commerce transaction, providing an online consumer with at least one of a selection of personalizing content, a mechanism for creating personalizing content, and a manner of uploading personalizing content, projecting the personalizing content onto the image of the article of merchandise to produce a composite image representing the article of merchandise as personalized by the personalizing content, and providing the composite image for display by a client device of the consumer to facilitate the electronic commerce transaction with the merchant.

15. The article of claim 14 further comprising instructions for accepting an order by the merchant from the consumer to purchase the article of merchandise as personalized by the composite image.

16. The article of claim 15 further comprising instructions for fulfilling an order by the merchant for purchase of the article of merchandise by the consumer, the article of merchandise corresponding to the image of the article of merchandise as personalized with the composite image.
